(19) United States
(12) Patent Application Publication
(10) Pub. No.: US 2025/0191292 A1
(43) Pub. Date: Jun. 12, 2025

(54) HANDLING DEVICE

(71) Applicant: EFFITO PTE. LTD., Singapore (SG)

(72) Inventors: Mu FANG, Singapore (SG); Bingchuan YANG, Singapore (SG); Yujie LU, Singapore (SG); Zhilong LI, Singapore (SG); Jinmei HUANG, Singapore (SG)

(21) Appl. No.: 18/975,190

(22) Filed: Dec. 10, 2024

(30) Foreign Application Priority Data
Dec. 11, 2023 (CN) 202323384468.9

(51) Int. Cl. G06T 17/00; G01S 17/42

(52) U.S. Cl. CPC G06T 17/00; G01S 17/42

(57) ABSTRACT

The present disclosure discloses a handling device and a method applied to the handling device, a controller and a plurality of 3D laser radars are arranged on a vehicle body of the handling device, the controller is in communication connection with the plurality of 3D laser radars, the plurality of 3D laser radars are configured to acquire 3D point cloud data of environment regions in a plurality of different orientations of the vehicle body, and the controller may determine the pose of the handling device according to the plurality of 3D point cloud data to position the handling device.

### CROSS REFERENCE TO RELATED APPLICATIONS

The present application claims a priority to a Chinese Patent Application with the corresponding application number being 202323384468.9 and the application date being Dec. 11, 2023, the entire contents of which are incorporated herein by reference.

### TECHNICAL FIELD

The present disclosure relates to the technical field of handling devices, and in particular, to a handling device and a method applied to a handling device.

### BACKGROUND

In order to implement autonomous positioning of the handling device, a two-dimensional (2D) barcode positioning and navigation method is generally adopted. Specifically, a plurality of different 2D barcodes are arranged in the environment regions where the handling device is located, and a camera is arranged at the top of the handling device. The handling device acquires the 2D barcode corresponding to the current position of the handling device through the camera, such that the handling device may determine the current position of the handling device according to the acquired 2D barcode, achieving positioning of the handling device.

### SUMMARY

Embodiments of the present disclosure discloses a handling device, including: a vehicle body; a plurality of 3D laser radars arranged on the vehicle body, where the plurality of 3D laser radars are configured to acquire 3D point cloud data of environment regions in a plurality of different orientations of the vehicle body, and the plurality of different orientations include at least two of a first side orientation, a second side orientation, and a front orientation of the vehicle body; and a controller, arranged on the vehicle body and in communication connection with the plurality of 3D laser radars, where the controller is configured to determine a pose of the handling device according to the 3D point cloud data acquired by the plurality of 3D laser radars.

Embodiments of the present disclosure discloses a method applied to a handling device, the handling device includes a vehicle body and a plurality of 3D laser radars arranged on the vehicle body, and the method includes: acquiring, by the plurality of 3D laser radars, 3D point cloud data of environment regions in a plurality of different orientations of the vehicle body, where the plurality of different orientations include at least two of a first side orientation, a second side orientation, and a front orientation of the vehicle body; and determining a pose of the handling device according to the acquired 3D point cloud data.

Embodiments of the present disclosure have the following beneficial effects.

According to the handling device provided by the embodiments of the present disclosure, the controller and the plurality of 3D laser radars are arranged on the vehicle body, the controller is in communication connection with the plurality of 3D laser radars, the plurality of 3D laser radars are configured to acquire 3D point cloud data of environment regions in a plurality of different orientations of the vehicle body, and the controller may determine the pose of the handling device according to the 3D point cloud data of the environment regions in a plurality of different orientations to position the handling device, such that the QR codes do not need to be arranged in the environment region where the handling device is located, which reduces the positioning costs of the handling device.

Meanwhile, a plurality of 3D laser radars are arranged on the vehicle body, the 3D point cloud data corresponding to environment regions in at least two orientations of the first side orientation, the second side orientation and the front orientation of the vehicle body may be acquired, such that the controller can obtain rich 3D point cloud data corresponding to the environment regions where the handling device is located, that is, the controller may use more 3D point cloud data corresponding to the environment regions where the handling device is located for positioning, thereby greatly improving the positioning precision and reliability of the handling device.

### BRIEF DESCRIPTION OF DRAWINGS

In order to more clearly illustrate the technical solutions in the embodiments of the present disclosure, the accompanying drawings required to be used in the embodiments are briefly described below, and obviously, the accompanying drawings in the following description are merely some embodiments of the present disclosure, and for those skilled in the art, other drawings may be obtained according to these accompanying drawings without creative efforts.

FIG. 1 is a three-dimensional structure diagram of a handling device at a viewing angle according to embodiments of the present disclosure.

FIG. 2 is a structure diagram of a communication connection relationship of a handling device according to embodiments of the present disclosure.

FIG. 3 is a three-dimensional structure diagram of a handling device at another viewing angle according to embodiments of the present disclosure.

FIG. 4 is a first structure diagram of a handling device according to embodiments of the present disclosure.

FIG. 5 is a second structure diagram of a handling device according to embodiments of the present disclosure.

FIG. 6 is a three-dimensional structure diagram of a handling device at another viewing angle according to embodiments of the present disclosure.

FIG. 7 is a third structure diagram of a handling device according to embodiments of the present disclosure.

FIG. 8 is a structure diagram of another communication connection relationship of a handling device according to embodiments of the present disclosure.

FIG. 9 is a structure diagram of a vehicle body and an anti-collision component of a handling device according to embodiments of the present disclosure.

FIG. 10 is a partial enlarged view of A in FIG. 1.

FIG. 11 is a partial enlarged view of B in FIG. 3.

FIG. 12 is a flowchart of a method applied to a handling device according to embodiments of the present disclosure.

### DETAILED DESCRIPTION

For ease of understanding the present disclosure, the present disclosure will be described more fully below with reference to the accompanying drawings. Embodiments of the present disclosure are presented in the accompanying drawings. However, the present disclosure may be implemented in many different forms and is not limited to the embodiments described herein. Rather, these embodiments are provided to make the disclosure of the present disclosure more thorough and comprehensive.

Unless otherwise defined, all technical and scientific terms used herein have the same meaning as commonly understood by those belonging to the technical field of the present disclosure. The terms in the specification of the present disclosure are used for the purpose of describing specific embodiments only, and are not intended to limit the present disclosure.

It may be understood that, the terms “first”, “second” and the like used herein may be used to describe various elements, but these elements are not limited by these terms. These terms are only used to distinguish a first element from another element.

It may be understood that, “connected” in the following embodiments should be understood as “electrical connection”, “communication connection”, etc., if the connected circuits, modules, units, etc. transmit position information or data between each other.

As used herein, the singular forms “a,” “an,” and “said/the” may also include the plural forms unless the context clearly indicates otherwise. It should further be understood that, the terms “include/comprise” or “have” etc., specify the presence of stated features, integers, steps, operations, assemblies, parts, or combinations thereof, but do not preclude the possibility of the presence or addition of one or more other features, integers, steps, operations, assemblies, parts, or combinations thereof. Meanwhile, the term “and/or” as used in this specification includes any and all combinations of the listed items.

At present, in order to complete the handling task through the handling device, the handling device is required to determine its own position; illustratively, if the handling device is required to automatically handle the goods from a first position to a second position, the handling device is required to determine the current position of the handling device, and then the handling device plans a movement path from the current position to the first position, moves to the first position according to the movement path to acquire the goods, and handles the goods to the second position.

As described in the background, in the related art, a 2D barcode positioning and navigation method is generally adopted to implement a positioning function of a handling device, however the 2D barcode positioning and navigation method needs to arrange a plurality of 2D barcodes in the environment regions where the handling device is located. This leads to higher positioning costs of the handling device. In view of this, an embodiment of the present disclosure provides a handling device, where the handling device is provided with a plurality of three-dimensional (3D) laser radars on a vehicle body, and the plurality of 3D laser radars may acquire 3D point cloud data of environment regions in a plurality of different orientations of the vehicle body, and the 3D point cloud data of the environment regions in the plurality of different orientations acquired by the plurality of 3D laser radars may be used as positioning data of the handling device, that is, the handling device may determine a pose of the handling device according to the 3D point cloud data of the environment regions in the plurality of different orientations, thereby positioning the handling device. Therefore, a plurality of 2D barcodes do not need to be arranged in the region where the handling device moves, greatly reducing the positioning costs of the handling device.

For example, the handling device may be provided with a controller, and the controller is in communication connection with the plurality of 3D laser radars, to acquire the 3D point cloud data respectively acquired by the plurality of 3D laser radars, and determine a pose of the handling device according to the 3D point cloud data, to implement positioning of the handling device.

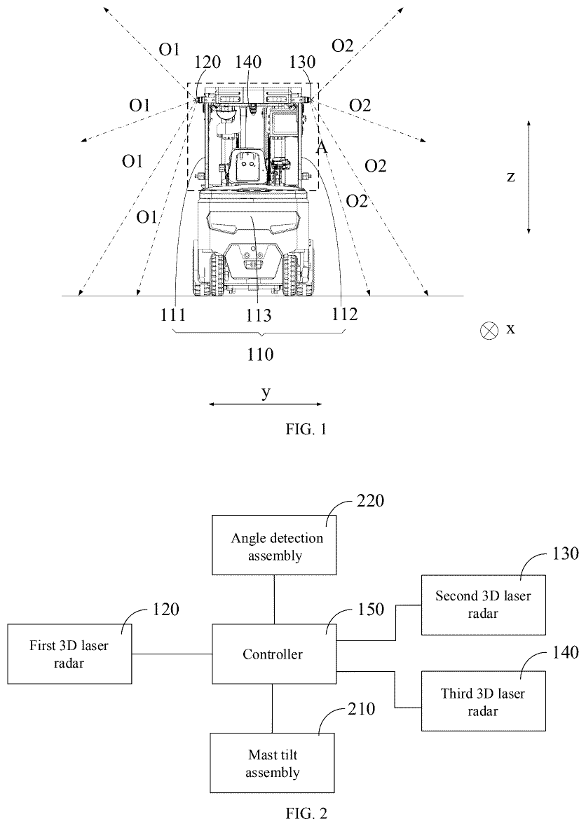

Referring to FIG. 1 and FIG. 2, FIG. 1 shows a three-dimensional structure diagram of a handling device at a viewing angle according to embodiments of the present disclosure, and FIG. 2 is a structure diagram of a communication connection relationship of a handling device according to embodiments of the present disclosure. In the embodiments of the present disclosure, the handling device may include an automated guided vehicle (AGV), e.g., a pallet forklift, a stacking forklift, and a counterweight forklift. It may be understood that, the pallet forklift refers to a forklift without a mast, and is mainly applied to a plan handling scenario. The stacking forklift refers to a wheeled handling vehicle for loading, unloading, piling up, stacking, and short-distance transportation of palletized goods, and the stacking forklift is provided with a mast, but is not provided with a cab, which may improve the flexibility of handling and stacking operations. The forks of the counterweight forklift are outside the front wheel center line, and is mainly characterized in that, in order to overcome the overturning moment generated by goods, a counterweight is mounted on the tail of the forklift.

As shown in FIG. 1 and FIG. 2, the handling device provided in the embodiment of the present disclosure may include a vehicle body 110, a plurality of 3D laser radars (at least two of a first 3D laser radar 120, a second 3D laser radar 130, and a third 3D laser radar 140 as shown in FIG. 1), and a controller 150, where the controller 150 and the plurality of 3D laser radars are separately arranged on the vehicle body 110, the controller 150 is in communication connection with the plurality of 3D laser radars, the plurality of 3D laser radars are configured to acquire 3D point cloud data of environment regions in a plurality of different orientations of the vehicle body 110, and the controller 150 is configured to determine a pose of the handling device according to the 3D point cloud data acquired by the plurality of 3D laser radars, to position the handling device, where the plurality of 3D laser radars may be configured to acquire 3D point cloud data of environment regions in at least two orientations of a first side orientation, a second side orientation, and a front orientation of the vehicle body 110.

It should be noted that, the 3D point cloud data of the environment regions in the plurality of different orientations of the vehicle body may refer to 3D point cloud data generated by scanning the environment regions in the plurality of different orientations of the vehicle body through plurality of 3D laser radars. The vehicle body 110 may be provided with two or more 3D laser radars, and the two or more 3D laser radars may acquire 3D point cloud data of environment regions in the plurality of different orientations of the vehicle body 110. In the embodiment of the present disclosure, by using two or more 3D laser radars to scan the environment region, it is possible to perform three-dimensional measurements of the environment regions in a plurality of different orientations of the vehicle body 110. Compared to a two-dimensional measurement assembly on the vehicle body 110, the scanning region of the 3D laser radar is larger, and the positioning precision of the handling device is higher.

Referring to FIG. 1, a travel direction of the handling device is parallel to a length direction x of the vehicle body 110; the width direction y, the length direction x and the height direction z are perpendicular to each other; and the vehicle body 110 is used as a reference object, such that the environment regions where the vehicle body 110 is located may be divided into an environment region in a first side orientation of the vehicle body 110, an environment region in a second side orientation of the vehicle body 110, an environment region in a front orientation of the vehicle body 110, and an environment region in a rear orientation of the vehicle body 110. The environment region in the first side orientation of the vehicle body 110 may be a region at a left side of the first side surface 111 of the vehicle body 110 in the width direction y, the environment region in the second side orientation of the vehicle body 110 may be a region on a right side orientation of the second side surface 112 of the vehicle body 110 in the width direction y, the environment region in the front orientation of the vehicle body 110 may be a region in the front of the front end 113 of the vehicle body 110 in the length direction x, and the rear region of the vehicle body 110 may be a region behind the rear end of the vehicle body 110 in the length direction x. It may be understood that, the handling device is provided with a fork assembly, the fork assembly is movably connected to the rear end of the vehicle body 110, the fork assembly may be used to handle an object, the front end 113 of the vehicle body 110 is an end of the vehicle body 110 away from the fork assembly, the first side orientation may be one of the left orientation and right orientation of the vehicle body 110, and the second side orientation may be another of the left orientation and right orientation of the vehicle body 110.

It should be noted that, during the movement of the handling device, the plurality of 3D laser radars arranged on the vehicle body 110 scan the environment regions in the plurality of different orientations of the vehicle body 110, to acquire the 3D point cloud data of the environment regions of the vehicle body 110 in the plurality of different orientations, such that the controller 150 may position the handling device based on the 3D point cloud data acquired by the plurality of 3D laser radars, and a plurality of QR codes do not need to be arranged in the region where the handling device moves, which may greatly reduce the positioning costs of the handling device. It may be understood that, the controller 150 may adopt any module capable of implementing a function of determining a pose of the handling device according to 3D point cloud data acquired by a plurality of 3D laser radars, e.g., a processor configured with a laser simultaneous localization and mapping (SLAM) algorithm program, and the processor may include an industrial control computer, that is, the controller 150 may implement a laser SLAM function.

It should be noted that, the environment region in the first side orientation of the vehicle body may include an upper environment region in the first side orientation and a lower environment region in the first side orientation of the vehicle body 110. In an embodiment, as shown in FIG. 1, the plurality of 3D laser radars may include a first 3D laser radar 120, and the first 3D laser radar 120 may be used to emit a first light ray O1 to a region at the left side of the first side surface 111 of the vehicle body 110, so as to acquire 3D point cloud data of a lower environment region in the environment region in the first side orientation, e.g., the 3D point cloud data of a road surface region in the environment region in the first side orientation, and acquire the 3D point cloud data of an upper environment region in the environment region in the first side orientation, e.g., the 3D point cloud data of objects (e.g., a sign building, a road sign, and a shelf) in the environment region in the first side orientation.

It should be noted that, the environment region in the second side orientation of the vehicle body may include an upper environment region in the second side orientation and a lower environment region in the second side orientation of the vehicle body 110. In an embodiment, as shown in FIG. 1, the plurality of 3D laser radars may include a second 3D laser radar 130, and the second 3D laser radar 130 may be used to emit a second light ray O2 to a region at the right side of the second side surface 112 of the vehicle body 110, so as to acquire 3D point cloud data of a lower environment region in the environment region in the second side orientation, e.g., the 3D point cloud data of a road surface region in the environment region in the second side orientation, and acquire the 3D point cloud data of an upper environment region in the environment region in the second side orientation, e.g., the 3D point cloud data of objects (e.g., a sign building, a road sign, and a shelf) in the environment region in the second side orientation.

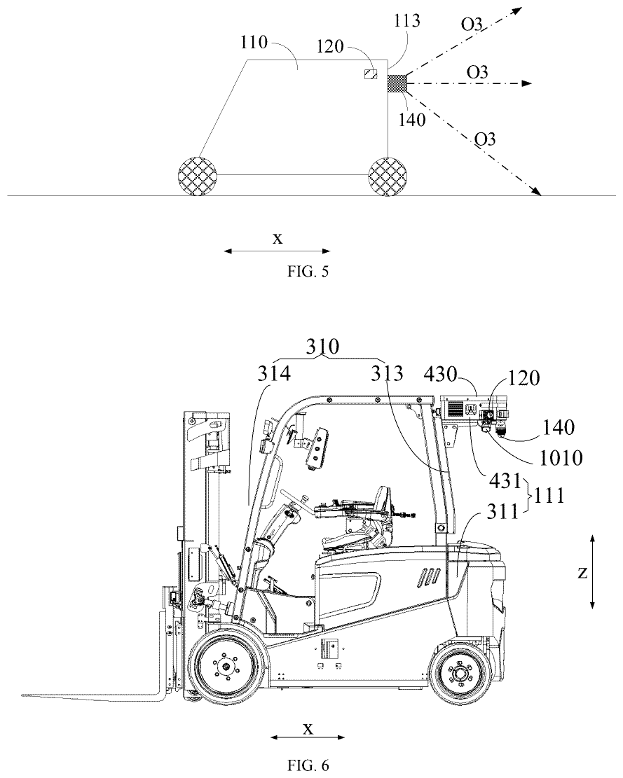

It should be noted that the front environment region of the vehicle body may include a front upper environment region and a front lower environment region of the vehicle body 110. In an embodiment, as shown in FIG. 5, the plurality of 3D laser radars may include a third 3D laser radar 140, and the third 3D laser radar 140 may be used to emit a third light ray O3 to a region in front of the front end 113 of the vehicle body 110, so as to acquire 3D point cloud data of a lower environment region in the environment region in the front orientation, e.g., the 3D point cloud data of a road surface region in the environment region in the front orientation, and acquire the 3D point cloud data of an upper environment region in the environment region in the front orientation, e.g., the 3D point cloud data of objects (e.g., a sign building, a road sign, and a shelf) in the environment region in the front orientation.

In some embodiments, each 3D laser radar may be used to scan environment regions in different orientations of the vehicle body 110, and the scanning regions of two 3D laser radars may partially overlap, or scanning regions of each 3D laser radar may not overlap with each other.

In the embodiment of the present disclosure, a plurality of 3D laser radars are arranged on the vehicle body 110, to scan environment regions in at least two orientations among an environment region in the first side orientation, an environment region in the second side orientation, and an environment region in the front orientation of the vehicle body 110, to acquire 3D point cloud data of at least two environment regions among an environment region in the first side orientation, an environment region in the second side orientation, and an environment region in the front orientation of the vehicle body 110. Meanwhile, the plurality of 3D laser radars are used to scan the environment regions in a plurality of different orientations of the vehicle body 110, which may perform three-dimensional measurements of the environment regions in a plurality of different orientations of the vehicle body 110 to obtain three-dimensional point cloud data, such that the controller 150 may obtain more abundant information of the environment regions where the vehicle body 110 is located, which thereby greatly improves the positioning precision and positioning reliability of the handling device.

In an embodiment, the plurality of 3D lasers may include at least two of the first 3D laser radar 120, the second 3D laser radar 130, and the third 3D laser radar 140. The first 3D laser radar 120 is arranged on the first side surface 111 of the vehicle body 110 and configured to acquire the first 3D point cloud data of an environment region in the first side orientation of the vehicle body 110, the second 3D laser radar 130 is arranged on the second side surface 112 of the vehicle body 110 and configured to acquire the second 3D point cloud data of an environment region in the second side orientation of the vehicle body 110, and the third 3D laser radar 140 is arranged on the front end 113 of the vehicle body 110 and configured to acquire the third 3D point cloud data of an environment region in the front orientation of the vehicle body 110. The controller 150 is in communication connection with the first 3D laser radar 120, the second 3D laser radar 130, and the third 3D laser radar 140 respectively, and the controller 150 is further configured to determine a pose of the handling device according to the first 3D point cloud data, the second 3D point cloud data, and the third 3D point cloud data, so as to position the handling device.

The first 3D point cloud data of the environment region in the first side orientation of the vehicle body 110 refers to the 3D point cloud data generated by the first 3D laser radar 120 scanning the environment region in the first side orientation of the vehicle body 110; the second 3D point cloud data of the environment region in the second side orientation of the vehicle body 110 refers to the 3D point cloud data generated by the second 3D laser radar 130 scanning the environment region in the second side orientation of the vehicle body 110; and the third 3D point cloud data of the environment region in the front orientation of the vehicle body 110 refers to the 3D point cloud data generated by the third 3D laser radar 140 scanning the environment region in the front orientation of the vehicle body 110. The first side surface 111 of the vehicle body 110 may be one of a left side surface and a right side surface of the vehicle body 110, and the second side surface 112 of the vehicle body 110 may be another of the left side surface and the right side surface of the vehicle body 110; if the first side surface 111 of the vehicle body 110 is the left side surface, and the second side surface 112 of the vehicle body 110 is the right side surface, then the first 3D laser radar 120 arranged on the first side surface 111 of the vehicle body 110 may be configured to acquire the first 3D point cloud data of an environment region at the left side of the vehicle body 110, and the second 3D laser radar 130 arranged on the second side surface 112 of the vehicle body 110 may be configured to acquire the second 3D point cloud data of an environment region at the right side of the vehicle body 110. If the first side surface 111 of the vehicle body 110 is the right side surface, and the second side surface 112 of the vehicle body 110 is the left side surface, then the first 3D laser radar 120 arranged on the first side surface 111 of the vehicle body 110 may be configured to acquire the first 3D point cloud data of the environment region at the right side of the vehicle body 110, and the second 3D laser radar 130 arranged on the second side surface 112 of the vehicle body 110 may be configured to acquire the second 3D point cloud data of the environment region at the left side of the vehicle body 110.

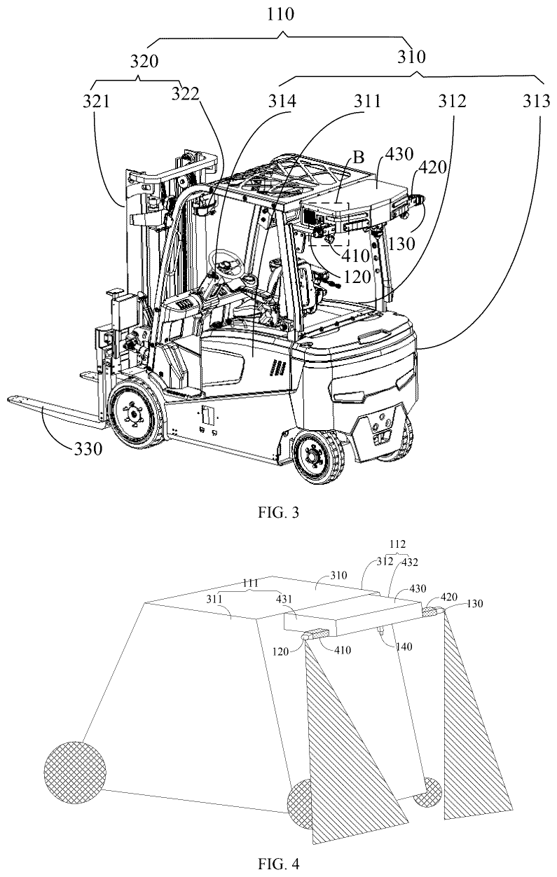

In an embodiment, referring to FIG. 3, the vehicle body 110 may include a vehicle main body 310 and a mast 320, the first side surface 111 of the vehicle body 110 may include a first side sub-surface 311 of the vehicle main body 310 and a fifth side sub-surface 321 of the mast 320, the second side surface 112 of the vehicle body 110 may include a third side sub-surface 312 of the vehicle main body 310 and a sixth side sub-surface 322 of the mast, the front end 113 of the vehicle body 110 includes the front end 313 of the vehicle main body 310, the rear end of the vehicle body 110 includes a rear end 314 of the vehicle main body 310, the mast 320 is fixedly connected to the rear end 314 of the vehicle main body 310, the first 3D laser radar 120 may be arranged on the first side sub-surface 311 of the vehicle main body 310 or the fifth side sub-surface 321 of the mast 320, and the second 3D laser radar 130 may be arranged on the third side sub-surface 312 of the vehicle main body 310 or the sixth side sub-surface 322 of the mast 320.

In an embodiment, still referring to FIG. 2 to FIG. 3, the handling device may further include a mast tilt assembly 210 and an angle detection assembly 220, the mast tilt assembly 210 is connected to the mast 320, the angle detection assembly 220 is arranged on the mast 320, both the mast tilt assembly 210 and the angle detection assembly 220 are in communication connection with the controller 150, the mast tilt assembly 210 is configured to drive the mast 320 to tilt forward or backward to handle or unload goods, the angle detection assembly 220 may be configured to detect a tilt angle of the mast 320, and the controller 150 is configured to receive the tilt angle of the mast 320 sent by the angle detection assembly 220, and control the mast tilt assembly 210 to adjust the tilt angle of the mast 320 to a target tilt angle according to the tilt angle. The target tilt angle may be preset in the controller 150, and the target tilt angle may be set according to needs.

In the embodiment of the present disclosure, respective 3D laser radars are respectively arranged on surfaces (e.g., the first side surface 111, the second side surface 112, or the front end 113 of the vehicle body 110) of the vehicle body 110 corresponding to environment regions in different orientations that needs to be acquired, such that the 3D laser radars may scan the environment region where the corresponding surface is located, to acquire 3D point cloud data of environment regions in a plurality of different orientations of the vehicle body 110, so as to enable the positioning precision of the handling device to be higher and reduce the design difficulty of a position of the 3D laser radar on the vehicle body 110.

In an embodiment, the controller 150 is further configured to determine whether there is an obstacle in the environment regions in a plurality of different orientations of the vehicle body 110 according to the 3D point cloud data of the environment regions in the plurality of different orientations of the vehicle body 110. In some embodiments, the handling device includes at least one of the first 3D laser radar 120, the second 3D laser radar 130, and the third 3D laser radar 140, and the controller 150 may further be configured to determine whether there is an obstacle in the environment region in the first side orientation of the vehicle body 110 according to the first 3D point cloud data acquired by the first 3D laser radar 120, and/or, whether there is an obstacle in the environment region in the second side orientation of the vehicle body 110 according to the second 3D point cloud data acquired by the second 3D laser radar 130, and/or, whether there is an obstacle in the environment region in the front orientation of the vehicle body 110 according to the third 3D point cloud data acquired by the third 3D laser radar 140.

It should be noted that, for ease of description, the obstacle in the environment region in the first side orientation of the vehicle body 110 is referred to as the first obstacle, the obstacle in the environment region in the second side orientation of the vehicle body 110 is referred to as the second obstacle, and the obstacle in the environment region in the front orientation of the vehicle body 110 is referred to as the third obstacle. Since the first 3D laser radar 120 may scan the environment region in the first side orientation of the vehicle body 110, in a case where the first obstacle exists in the environment region in the first side orientation of the vehicle body 110, the 3D point cloud data corresponding to the first obstacle exists in the first 3D point cloud data acquired by the first 3D laser radar 120, such that the controller 150 may determine whether the first obstacle exists in the environment region in the first side orientation by determining whether the 3D point cloud data of the first obstacle exists in the first 3D point cloud data. Similarly, the controller 150 may further determine whether the second obstacle exists in the environment region in the second side orientation by determining whether the 3D point cloud data of the second obstacle exists in the second 3D point cloud data. Similarly, the controller 150 may further determine whether the third obstacle exists in the environment region in the third side orientation by determining whether the 3D point cloud data of the third obstacle exists in the third 3D point cloud data.

In some embodiments, the controller 150 is further configured to control the movement of the handling device to bypass the first obstacle, the second obstacle, and the third obstacle, so as to prevent the handling device from colliding with the first obstacle, the second obstacle and the third obstacle.

It may be understood that, in the embodiment, the controller 150 may use a functional module configured with a program for identifying the point cloud data of an obstacle, to identify whether the first 3D point cloud data, the second 3D point cloud data, or the third 3D point cloud data contains the point cloud data of an obstacle, to implement an obstacle avoidance function of the handling device. The functional module having a program for identifying the point cloud data of an obstacle may be, for example, a processor executing the program for identifying the point cloud data of the obstacle.

In the embodiment, since the 3D laser radar may acquire three-dimensional (3D) point cloud data, the handling device provided in the present embodiment may implement the three-dimensional obstacle avoidance function in the side orientations (the first side orientation and the second side orientation) and the front orientation, without additionally arranging an obstacle avoidance sensor (e.g., a 2D laser radar arranged at the bottom of the vehicle body 110) on the vehicle body 110, thereby effectively simplifying the overall structure of the handling device and reducing the manufacturing costs of the handling device.

In an embodiment, the 3D point cloud data of the environment regions in a plurality of different orientations of the vehicle body 110 includes 3D point cloud data of a road surface region in the front orientation of the vehicle body 110, and the controller 150 is further configured to determine whether there is a void region in the road surface region according to the 3D point cloud data of the road surface region in the front orientation of the vehicle body 110.

It may be understood that, in a case where a void region exists in the road surface region, the 3D laser radar does not generate the 3D point cloud data corresponding to the void region, and the 3D laser radar may generate the 3D point cloud data corresponding to the non-void region in the road surface region. Therefore, in a case where the controller 150 identifies that a region without point cloud data exists in the acquired 3D point cloud data of the road surface region ahead, it may be determined that the road surface region corresponding to the region without point cloud data is a void region.

In some embodiments, the controller 150 is further configured to determine a distance between the handling device and a void region in the case where the void region exists in the road surface region ahead, and control a travel distance of the handling device, so as to prevent the handling device from falling into the void region, thereby implementing an anti-falling safety protection function of the handling device when traveling forward.

Referring to FIG. 4, which shows a structure diagram of a handling device according to embodiments of the present disclosure, as shown in FIG. 4, the handling device may include a first 3D laser radar 120 and a second 3D laser radar 130, where the first 3D laser radar 120 is further configured to acquire the fourth 3D point cloud data corresponding to a first road surface region in the front orientation of the vehicle body 110, the second 3D laser radar 130 is further configured to acquire the fifth 3D point cloud data corresponding to a second road surface region in the front orientation of the vehicle body 110, and the controller 150 is further configured to determine whether a void region exists in the first road surface region according to the fourth 3D point cloud data, and determine whether a void region exists in the second road surface region according to the fifth 3D point cloud data.

The fourth 3D point cloud data corresponding to the first road surface region in the front orientation of the vehicle body 110 refers to the 3D point cloud data generated by the first 3D laser radar 120 scanning the first road surface region. The fifth 3D point cloud data corresponding to the second road surface region in the front orientation of the vehicle body 110 refers to the 3D point cloud data generated by the second 3D laser radar 130 scanning the second road surface region. The environment region in the front orientation of the vehicle body 110 includes a road surface region in the front orientation of the vehicle body 110, the road surface region in the front orientation of the vehicle body 110 may be divided into the first road surface region and the second road surface region, the first road surface region is a road surface region close to the first side surface 111 of the vehicle body 110 in the environment region in the front orientation of the vehicle body 110, and the second road surface region is a road surface region close to the second side surface 112 of the vehicle body 110 in the environment region in the front orientation of the vehicle body 110. It should be noted that, the scanning region of the first 3D laser radar 120 may be adjusted by adjusting the angle formed between the first 3D laser radar 120 and the first side surface 111 of the vehicle body 110, such that the first 3D laser radar 120 may acquire the 3D point cloud data of the environment region in the first side orientation of the vehicle body 110 and the 3D point cloud data of the first road surface region. Similarly, the scanning region of the second 3D laser radar 130 may be adjusted by adjusting the angle formed between the second 3D laser radar 130 and the second side surface 112 of the vehicle body 110, such that the second 3D laser radar 130 may acquire the 3D point cloud data of the environment region in the second side orientation of the vehicle body 110 and the 3D point cloud data of the second road surface region.

It should be noted that, in a case where a region without point cloud data is identified to exist in the acquired fourth 3D point cloud data of the first road surface region, the controller 150 may determine that a region in the first road surface region corresponding to the region without point cloud data is a void region; and in a case where a region without point cloud data is identified to exist in the acquired fifth 3D point cloud data of the second road surface region, the controller 150 may determine that a region in the second road surface region corresponding to the region without point cloud data is a void region. Therefore, the controller 150 may determine whether a void region exists in the first road surface region according to the fourth 3D point cloud data acquired by the first 3D laser radar 120, and determine whether a void region exists in the second road surface region according to the fifth 3D point cloud data acquired by the second 3D laser radar 130.

In some embodiments, the controller 150 is further configured to determine a distance between the handling device and a void region in the case where the void region exists in the first road surface region and/or the second road surface region, and control a travel distance of the handling device, so as to prevent the handling device from falling into the void region, thereby implementing an anti-falling safety protection function of forward travel of the handling device.

It may be understood that, in a case where the third 3D laser radar 140 is provided and may acquire the 3D point cloud data of a road surface region in the front orientation of the vehicle body 110, the controller 150 may be further configured to determine whether a void region exists in the road surface region in the front orientation of the vehicle body 110 according to the 3D point cloud data of the road surface region in the front orientation of the vehicle body 110 acquired by the third 3D laser radar 140, which is not limited in the embodiment. The controller 150 may adopt a functional module configured with a program for identifying whether a region without point cloud data exists in 3D point cloud data acquired by a 3D laser radar, to determine whether a void region exists in a road surface region located in the front orientation of the vehicle body 110, thereby implementing control of the anti-falling safety protection function of the handling device.

In the embodiment, the angle formed between the 3D laser radar and the vehicle body 110 may be adjusted, such that the 3D laser radar may acquire the 3D point cloud data of the road surface region in the front orientation of the vehicle body 110, which may determine whether a void region exists in the road surface region in the front orientation of the vehicle body 110, preventing the handling device from falling into the void region, and implementing the anti-falling safety protection function of the handling device when traveling forward. Further, in the embodiment, the 3D laser radar may be configured to acquire the 3D point cloud data of the road surface region, which is more accurate than single-point laser detection and thereby improves the safety of the handling device.

In an embodiment, at least one of the first 3D laser radar 120, the second 3D laser radar 130, the third 3D laser radar 140, and the controller 150 may be arranged at the top of the vehicle body 110.

It should be noted that, as described in the foregoing embodiments, for the environment regions where the handling device is located, the obstacles in the environment region corresponding to the bottom of the vehicle body 110 of the handling device in the height direction z are more than the obstacles in the environment region corresponding to the top of the vehicle body 110 of the handling device in the height direction z, by arranging the first 3D laser radar 120, the second 3D laser radar 130, the third 3D laser radar 140, and the controller 150 at the top of the vehicle body 110, a probability that the first 3D laser radar 120, the second 3D laser radar 130, the third 3D laser radar 140, or the controller 150 is collided may be reduced, such that service lives of the first 3D laser radar 120, the second 3D laser radar 130, the third 3D laser radar 140, and the controller 150 are relatively long.

As described in the foregoing embodiments, the first 3D laser radar 120 may be configured to acquire 3D point cloud data of a lower environment region in the first side orientation, and the second 3D laser radar 130 may be configured to acquire 3D point cloud data of a lower environment region in the second side orientation, by arranging the first 3D laser radar 120 and the second 3D laser radar 130 at the top of the vehicle body 110, a distance between the first 3D laser radar 120 and the first road surface region in an environment region in the first side orientation may be relatively large, and a distance between the second 3D laser radar 130 and the second road surface region in an environment region in the second side orientation may be relatively large, such that the scanning regions of the first 3D laser radar 120 and the second 3D laser radar 130 are relatively large, that is, information of the environment regions corresponding to the acquired first 3D point cloud data and second 3D point cloud data is richer, which improves the positioning precision of the handling device.

In an embodiment, the 3D point cloud data of the environment regions in the plurality of different orientations of the vehicle body 110 includes 3D point cloud data of an environment region above the vehicle body 110, and the environment region above the vehicle body 110 is an environment region above the top of the vehicle body 110. The controller 150 is further configured to determine whether an obstacle exists in the environment region above the vehicle body 110 according to the 3D point cloud data of the environment region above the vehicle body 110. In the embodiment, at least one of the plurality of 3D laser radars is arranged at the top of the vehicle body 110, and the 3D laser radar arranged at the top may scan the environment region above the top of the vehicle body 110, so as to determine whether an obstacle exists in the environment region above the vehicle body 110, which improves the safety of the handling device. It should be noted that, an obstacle may exist in the environment regions where the handling device is located, e.g., an object hanging on the roof of the warehouse, by adjusting the angle between the 3D laser radar arranged at the top of the vehicle body 110 and the vehicle body 110, the light ray emitted by the 3D laser radar scans the environment region above to generate the 3D point cloud data of the environment region above of the vehicle body 110, so as to implement high-position detection of the handling device, and if there is an obstacle in the environment region above the vehicle body, the 3D point cloud data of the environment region above the vehicle body may include the obstacle, such that the controller 150 may determine whether an obstacle exists in the environment region above the vehicle body according to the 3D point cloud data of the environment region above the vehicle body. In some embodiments, when determining that an obstacle exists in the environment region above the vehicle body 110, the controller 150 may be further configured to control the movement of the handling device, so as to avoid collision between the handling device and the obstacle in the environment region above the vehicle body 110.

In some embodiments, referring to FIG. 5, the third 3D laser radar 140 is arranged at the top of the vehicle body 110, the third 3D point cloud data acquired by the third 3D laser radar 140 includes the first point cloud sub-data corresponding to an environment region above the vehicle body 110, and the controller 150 is further configured to determine whether an obstacle exists in the environment region above according to the first point cloud sub-data.

It should be noted that, by adjusting the angle between the third 3D laser radar 140 and the vehicle body 110, the third 3D laser radar 140 emits the third light ray O3, and scans the environment region above the vehicle body 110 to generate the first point cloud sub-data of the environment region above, because the third 3D laser radar 140 is arranged at the top of the vehicle body 110, by scanning the environment region above the top of the vehicle body 110, high-position detection of the handling device may be implemented, and if an obstacle exists in the environment region above, the first point cloud sub-data may include the point cloud data corresponding to the obstacle, therefore, the controller 150 may determine whether an obstacle exists in the environment region above the vehicle body according to the first point cloud sub-data. In some embodiments, when determining that an obstacle exists in the environment region above the vehicle body, the controller 150 may be further configured to control the movement of the handling device, so as to avoid collision between the handling device and the obstacle in the environment region above the vehicle body.

In the embodiment, at least one 3D laser radar is arranged at the top of the vehicle body 110, and the 3D laser radar may acquire 3D point cloud data of the environment region above the vehicle body, such that the controller 150 may determine whether an obstacle exists in the environment region above the top of the vehicle body 110, and control the handling device to avoid the obstacle when the controller 150 identifies that an obstacle exists and implement a high-position obstacle avoidance function of the handling device, such that an ultrasonic obstacle avoidance sensor and a photoelectric obstacle avoidance sensor do not need to be additionally arranged at the top of the handling device. In this way, the high obstacle avoidance function is realized, meanwhile the overall structure of the handling device is simplified and the manufacturing cost of the handling device is reduced.

As described in the foregoing embodiments, the scanning region of the first 3D laser radar 120 may be adjusted by adjusting the angle formed between the first 3D laser radar 120 and the vehicle body 110; similarly, the scanning region of the second 3D laser radar 130 may be adjusted by adjusting the angle formed between the second 3D laser radar 130 and the vehicle body 110; and similarly, the scanning region of the third 3D laser radar 140 may be adjusted by adjusting the angle formed between the third 3D laser radar 140 and the vehicle body 110. The following embodiment will provide an angle adjustment assembly to adjust the angle formed between the 3D laser radar and the vehicle body 110, so as to improve the positioning of the handling device and the precision of the anti-falling safety protection.

In an embodiment, the handling device may further include an angle adjustment assembly, and the 3D laser radar is arranged on the vehicle body 110 through the angle adjustment assembly to adjust an angle formed between the 3D laser radar and the vehicle body 110.

The handling device may include a plurality of angle adjustment assemblies, and the plurality of angle adjustment assemblies are in one-to-one correspondence with the plurality of 3D laser radars. For example, the handling device may include a first angle adjustment assembly corresponding to the first 3D laser radar 120, and/or a second angle adjustment assembly corresponding to the second 3D laser radar 130, and/or a third angle adjustment assembly corresponding to the third 3D laser radar 140, that is, the angle adjustment assembly of the handling device may include any one or more of the first angle adjustment assembly, the second angle adjustment assembly, and the third angle adjustment assembly.

Still referring to FIG. 4, the first angle adjustment assembly 410 is arranged on the first side surface 111 of the vehicle body 110, the first 3D laser radar 120 is arranged on the first side surface 111 of the vehicle body 110 through the first angle adjustment assembly 410, the first angle adjustment assembly 410 may be configured to adjust an angle formed between the first 3D laser radar 120 and the first side surface 111 of the vehicle body 110, the second angle adjustment assembly 420 is arranged on the second side surface 112 of the vehicle body 110, the second 3D laser radar 130 is arranged on the second side surface 112 of the vehicle body 110 through the second angle adjustment assembly 420, the second angle adjustment assembly 420 may be configured to adjust an angle formed between the second 3D laser radar 130 and the second side surface 112 of the vehicle body 110, the third angle adjustment assembly (not shown in FIG. 3) is arranged on the front end 113 of the vehicle body 110, the third 3D laser radar 140 is arranged on the front end 113 of the vehicle body 110 through the third angle adjustment assembly, and the third angle adjustment assembly may be configured to adjust an angle formed between the third 3D laser radar 140 and the front end 113 of the vehicle body 110.

It should be noted that, since angles formed between the first 3D laser radar 120 and the first side surface 111 of the vehicle body 110 are different, scanning regions of the first 3D laser radar 120 are also different; similarly, angles formed between the second 3D laser radar 130 and the second side surface 112 of the vehicle body 110 are different, then scanning regions of the second 3D laser radar 130 are also different; and similarly, angles formed between the third 3D laser radar 140 and the front end 113 of the vehicle body 110 are different, then scanning regions of the third 3D laser radar 140 are also different. When the handling device moves in different environment regions, optimal scanning regions of the first 3D laser radar 120 may be different, optimal scanning regions of the second 3D laser radar 130 may also be different, and optimal scanning regions of the third 3D laser radar 140 may also be different. For example, when the handling device moves in the first environment region, the positioning precision of the scanning region of the first 3D laser radar 120 being the first scanning region is higher than the positioning precision of the scanning region of the first 3D laser radar 120 being the second scanning region; and when the handling device moves in the second environment region, the positioning precision of the scanning region of the first 3D laser radar 120 being the second scanning region is higher than the positioning precision of the scanning region of the first 3D laser radar 120 being the first scanning region. Similarly, this phenomenon may also exist for the second 3D laser radar 130 and the third 3D laser radar 140. In the embodiment, by arranging the first angle adjustment assembly 410, the angle formed between the first 3D laser radar 120 and the first side surface 111 of the vehicle body 110 may be changed, so as to change the scanning region of the first 3D laser radar 120; by arranging the second angle adjustment assembly 420, the angle formed between the second 3D laser radar 130 and the second side surface 112 of the vehicle body 110 may be changed, so as to change the scanning region of the second 3D laser radar 130; by arranging the third angle adjustment assembly, the angle formed between the third 3D laser radar 140 and the front end 113 of the vehicle body 110 may be changed, so as to change the scanning region of the third 3D laser radar 140, such that the positioning precision of the handling device moving in a plurality of different environment regions is all higher, which improves the applicability and flexibility of the handling device.

In some embodiments, the angle adjustment assembly may move relative to the vehicle body 110, so as to drive the 3D laser radar connected to the angle adjustment assembly to move, so as to adjust the angle formed between the 3D laser radar and the vehicle body 110, thereby adjusting the scanning region of the 3D laser radar.

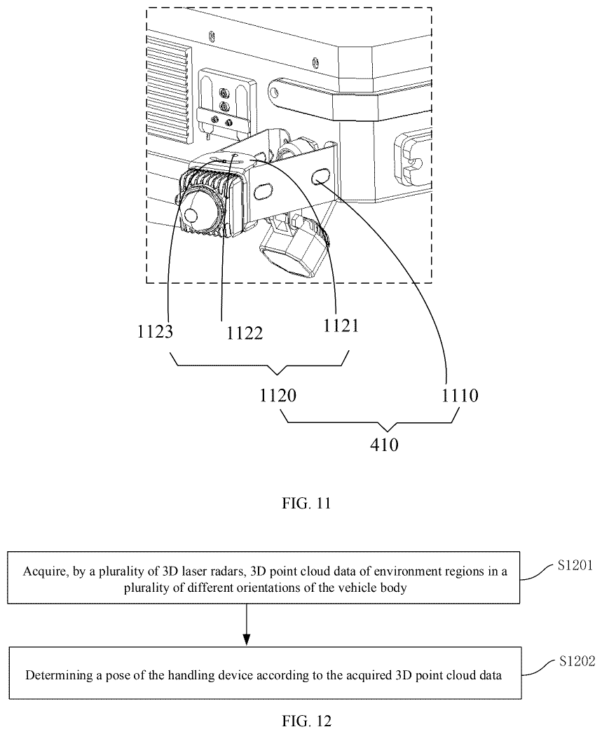

In an embodiment, referring to FIG. 11, a structure of each angle adjustment assembly is described by using the angle adjustment assembly 410 as an example, and a structure of other angle adjustment assemblies may refer to a structure of the angle adjustment assembly 410. Specifically, the angle adjustment assembly 410 may include a base 1110 and a rotating assembly 1120, one end of the base 1110 is fixedly connected to the vehicle body 110, the rotating assembly 1120 is rotatably connected to another end of the base 1110, the 3D laser radar corresponding to the angle adjustment assembly 410 is arranged on the rotating assembly 1120, and the rotating assembly 1120 is rotatable relative to the base 1110, so as to adjust an angle formed between the 3D laser radar and the vehicle body 110.

In an embodiment, still referring to FIG. 11, the rotating assembly 1120 may include a connecting element 1121, a first threaded fastener 1122 and a second threaded fastener 1123, the connecting element 1121 is connected to the 3D laser radar, the connecting element 1121 has a connecting hole and an arc-shaped hole, the first threaded fastener 1122 may pass through the connecting hole to be connected to the base 1110 of the angle adjustment assembly 410, in an unlocked state of the first threaded fastener 1122, the connecting element 1121 is rotatably connected to the base 1110 through the first threaded fastener 1122, that is, in the unlocked state, the first threaded fastener 1122 may be used as a rotating shaft for rotatably connecting the base 1110 and the connecting element 1121, the arc-shaped hole is arranged around the first threaded fastener 1122, and a circle center of the arc-shaped hole coincides with a rotation center formed by the first threaded fastener 1122 and the connecting hole, the second threaded fastener 1123 may pass through the arc-shaped hole to be connected to the base 1110 to connect the base 1110 and the connecting element 1121, and when the connecting element 1121 and the base 1110 rotate relatively, the second threaded fastener 1123 slides along the arc-shaped hole. It may be understood that, when the first threaded fastener 1122 and the second threaded fastener 1123 are in the locked (fixed) state, the connecting element 1121 and the base 1110 may be locked (fixed) to prevent the connecting element 1121 from rotating relative to the base 1110, which may improve the reliability of the handling device.

In the embodiment, a rotating component formed by the connecting element 1121, the first threaded fastener 1122 and the second threaded fastener 1123 may implement the rotating connection between the rotating component and the base 1110, and since the first threaded fastener 1122 and the second threaded fastener 1123 (e.g., a plurality of threaded fasteners) are used, the connection reliability between the connecting element 1121 and the base 1110 may be improved, that is, the connection reliability of the 3D laser radar and the vehicle body 110 is improved. Meanwhile, the first threaded fastener 1122 and the second threaded fastener 1123 include an unlocked state and a locked state, such that the angle formed between the 3D laser radar and the vehicle body 110 may be adjusted, unnecessary change of the angle formed between the 3D laser radar and the vehicle body 110 may be avoided, which improves the applicability and reliability of the handling device.

It may be understood that, the angle adjustment assembly 410 may adopt other forms, and is not limited to the forms provided in the foregoing embodiments, as long as the angle adjustment assembly 410 can adjust the angle formed between the 3D laser radar and the vehicle body 110.

In an embodiment, referring to FIG. 4 and FIG. 6, the vehicle body 110 of the handling device may include a vehicle main body 310 and a mounting box 430, the mounting box 430 is arranged on the front end 313 of the vehicle main body 310 in the length direction x, the controller 150 is arranged inside the mounting box 430, the first side surface 111 of the vehicle body 110 includes a first side sub-surface 311 of the vehicle main body 310 and a second side sub-surface 431 of the mounting box 430, and the second side surface 112 of the vehicle body 110 includes a third side sub-surface 312 of the vehicle main body 310 and a fourth side sub-surface of the mounting box 430. The first 3D laser radar 120 is arranged on the second side sub-surface 431 of the mounting box 430, and/or the second 3D laser radar 130 is arranged on the fourth side sub-surface 432 of the mounting box 430, and/or the third 3D laser radar 140 is arranged at the bottom of the mounting box 430 of the vehicle body 110 in the height direction Z.

It should be noted that the third 3D laser radar 140 is arranged at the bottom of the mounting box 430 in the height direction z of the vehicle body 110, that is, the third 3D laser radar 140 is arranged at the front end of the vehicle body 110 through the mounting box 430. In the embodiment, since the mounting box 430 is arranged at the front end 313 of the vehicle main body 310 compared with that the first 3D laser radar 120, the second 3D laser radar 130, and the third 3D laser radar 140 are arranged on the vehicle main body 310, the first 3D laser radar 120, the second 3D laser radar 130, and the third 3D laser radar 140 are respectively arranged on the second side sub-surface 431, the fourth side sub-surface 432, and the bottom of the mounting box 430, that is, the first 3D laser radar 120, the second 3D laser radar 130, and the third 3D laser radar 140 are arranged at a position away from the vehicle main body 310. This may reduce the sheltering of the scanning regions of the first 3D laser radar 120, the second 3D laser radar 130, and the third 3D laser radar 140 by the vehicle main body 310, such that the first 3D laser radar 120, the second 3D laser radar 130, and the third 3D laser radar 140 may collect 3D point cloud data less affected by the vehicle main body 310, which reduces the interference of the vehicle main body 310 on the 3D point cloud data. Meanwhile, the controller 150 is arranged inside the mounting box 430 to protect the controller 150.

In an embodiment, referring to FIG. 6, the mounting box 430 may be arranged at the top of the front end 313 of the vehicle main body 310, as described above, the mounting box 430 is arranged at the top of the front end 113 of the vehicle main body 310, such that the first 3D laser radar 120, the second 3D laser radar 130 and the third 3D laser radar 140 may be arranged at the top of the vehicle body 110, which may thereby reduce the probability that the first 3D laser radar 120, the second 3D laser radar 130 and the third 3D laser radar 140 are collided, and prolong the service life of the first 3D laser radar 120, the second 3D laser radar 130 and the third 3D laser radar 140.

In an embodiment, the handling device may further include an acquisition assembly, the controller 150 is further in communication connection with the fork assembly 330 and the acquisition assembly respectively, the fork assembly 330 is movably connected to the rear end of the vehicle body 110, the fork assembly 330 is configured to pick up a to-be-handled object, the acquisition assembly is arranged at the rear end of the vehicle body 110 and is configured to acquire object point cloud data of the to-be-handled object, and the controller 150 may be further configured to determine a pose of the to-be-handled object according to the object point cloud data of the to-be-handled object, to control the fork assembly 330 to handle the to-be-handled object.

It should be noted that the object point cloud data of the to-be-handled object refers to point cloud data corresponding to the to-be-handled object. The handling device is provided with a fork assembly 330 to pick up and carry a to-be-handled object, thereby implementing handling of the to-be-handled object. The acquisition assembly and the fork assembly 330 are arranged on the same side, and when the handling device is close to the to-be-handled object, the acquisition assembly may acquire object point cloud data of the to-be-handled object, such that the controller 150 may acquire the object point cloud data to determine a pose of the to-be-handled object, so as to adjust the pose of the fork assembly 330, such that the pose of the fork assembly 330 corresponds to the pose of the to-be-handled object, to implement that the fork assembly 330 handles the to-be-handled object. In some embodiments, the acquisition assembly may include a 3D laser radar, the 3D laser radar is arranged to scan the to-be-handled object, and compared to the 2D laser radar, information of the to-be-handled object in the height direction z may be acquired, such that the controller 150 may determine a pose of the to-be-handled object in the height direction z, thereby improving handling precision and reliability of the handling device.

In some embodiments, the fork assembly 330 is movably arranged on the mast 320 of the vehicle body 110, and the fork assembly 330 may move relative to the vehicle body 110 in the height direction z of the vehicle body 110 to handle objects to be handled at different positions in the height direction z, which thereby improves applicability of the handling device.

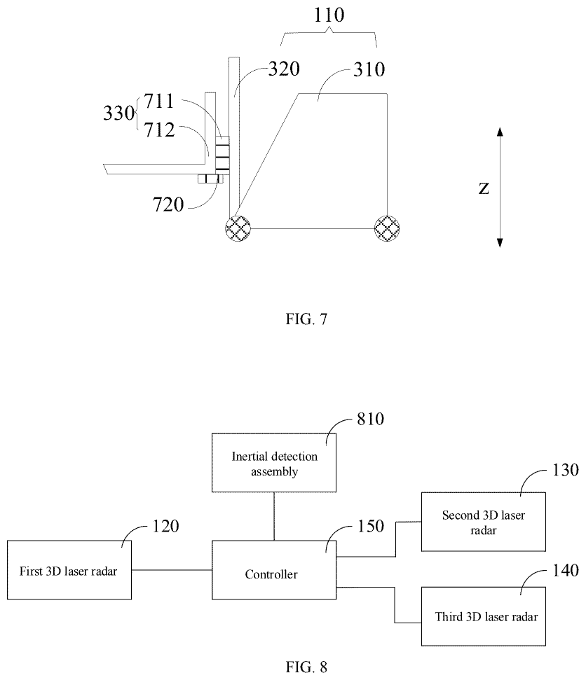

In an embodiment, as shown in FIG. 7, the fork assembly 330 may include a movable component 711 and two forks 712, the movable component 711 is movably connected to the rear end of the vehicle body 110, the two forks 712 are arranged on the movable assembly 711 spaced apart, and the acquisition assembly is between the two forks 712. For example, the movable component 711 is movably connected to the mast 320.

It should be noted that, the two forks 712 are configured to pick up a to-be-handled object to implement handling of the to-be-handled object. Since a scanning region of an acquisition assembly (e.g., a 3D laser radar) is limited, compared to a case where the acquisition assembly is arranged on a side of one fork away from the other fork, the acquisition assembly is arranged between the two forks, an acquisition assembly with a smaller scanning region may be used to acquire point cloud data of the to-be-handled object, without the need to use an acquisition assembly with a larger scanning region, which enables the manufacturing costs of the handling device to be lower while a pose of the to-be-handled object is determined. In some embodiments, referring to FIG. 7, the movable component 711 is movably connected to the mast 320, and since the mast 320 is arranged on the rear end of the vehicle body 110, the movable component 711 is movably connected to the rear end of the vehicle main body 310.

In an embodiment, the acquisition assembly may be arranged on the fork assembly 330 to move with the movement of the fork assembly 330, such that the acquisition assembly may acquire point cloud data of to-be-handled objects on different positions in the height direction z, which improves applicability of the handling device.

Still referring to FIG. 7, the handling device may further include a height measuring assembly 720. The fork assembly 330 can move relative to the vehicle body 110 in the height direction z of the vehicle body 110 to change a position of the fork assembly 330 in the height direction z. The height measurement assembly 720 is arranged on the fork assembly 330, the height measurement assembly 720 is in communication connection with the controller 150. The height measurement assembly 720 is configured to detect a fork height position of the fork assembly 330 in the height direction z, and the controller 150 is further configured to control the fork assembly 330 to move according to the fork height position of the fork assembly 330 in the height direction z, so as to adjust the fork height position of the fork assembly 330 in the height direction z to a target height position corresponding to the target position.

It may be understood that, the handling device provided in the embodiment may be used to handle the to-be-handled goods. The handling device picks up the to-be-handled goods through the fork assembly 330, to pick up the goods from the target position or to unload the goods onto the target position. If the fork height position of the fork assembly 330 in the height direction z does not match the target height position in the height direction z at the target position, it is necessary to adjust the fork height position of the fork assembly 330 in the height direction z to the target height position, in order to pick up the goods from the target position or to unload the goods onto the target position.

It should be noted that the controller 150 may determine the target height position corresponding to the target position, e.g., the controller 150 stores the target height position in advance corresponding to the target position, or the controller 150 may receive the target height position corresponding to the target position sent by another device, and the controller 150 is in communication connection with the height measurement assembly 720, to determine the fork height position of the fork assembly 330 in the height direction z through the height measurement assembly 720. The controller 150 may adjust the fork height position of the fork assembly 330 in the height direction z to the target height position corresponding to the target position according to the target height position and the fork height position of the fork assembly 330 in the height direction z detected by the height measurement assembly 720, to pick up the goods from the target position, or unload the goods to the target position.

In an embodiment, the height measurement assembly 720 may include a draw wire encoder, the draw wire encoder may include a draw wire encoder body and a draw wire retractable relative to the draw wire encoder body, the draw wire encoder body is in communication connection with the controller 150, the draw wire encoder body may be mounted on the fork assembly 330, a free end of the draw wire is connected to the bottom of the vehicle body 110, the extension and retraction direction of the draw wire is perpendicular to the ground. The draw wire encoder body may be used to calculate a drawn length of the draw wire, that is, determine a fork height position of the fork assembly 330 in the height direction z, and send the fork height position to the controller 150, such that the controller 150 may determine the fork height position of the fork assembly 330 in the height direction z.

It may be understood that, the draw wire encoder body may also be arranged at the bottom of the vehicle body 110, and the free end of the draw wire is connected to the fork assembly 330, which is not limited in the embodiments, as long as the height position of the fork assembly 330 in the height direction z can be detected.

In an embodiment, as shown in FIG. 8, the handling device may further include an inertial detection assembly 810, the inertial detection assembly 810 is arranged on the vehicle body 110, the inertial detection assembly 810 is in communication connection with the controller 150, the inertial detection assembly 810 may be configured to detect posture information of the handling device, and the controller 150 is further configured to receive the posture information of the handling device, and determine a pose of the handling device according to the 3D point cloud data acquired by the plurality of 3D laser radars and the posture information of the handling device, to position the handling device. The posture information may include acceleration and angular velocity of the handling device.

It should be noted that, by arranging the inertial detection assembly 810 on the vehicle body 110, the inertial detection assembly 810 moves along with the movement of the handling device (movement on the road surface region), which may thereby detect the posture information of the handling device. In some embodiments, the inertial detection assembly 810 may include a six-axis inertial measurement unit (IMU). The controller 150 may determine a travel distance of the handling device according to the posture information (acceleration and angular velocity), and determine a first current position of the handling device according to the travel distance and an initial position of the handling device. The controller 150 may further determine a second current position of the handling device according to data of a plurality of 3D point clouds, and the controller 150 may be further configured to position the handling device according to the first current position and the second current position. The controller 150 may be any module capable of implementing a function of determining a pose of the handling device according to 3D point cloud data and posture information acquired by a plurality of 3D laser radars, e.g., a processor configured with an IMU integrated with simultaneous localization and mapping (SLAM) algorithm program, that is, the controller 150 may implement the IMU integrated with SLAM function.

It may be understood that, the inertial detection assembly 810 such as a six-axis IMU may detect the posture information of the handling device at a high frequency, so in the embodiment, by acquiring the posture information and the data of a plurality of 3D point clouds, it may be ensured that the positioning precision of the handling device is higher when the handling device moves rapidly.

In the embodiment, by arranging a plurality of 3D laser radars and inertial detection assemblies 810, the controller 150 may acquire 3D point cloud data of the environment regions in a plurality of different orientations of the vehicle body 110 and posture information corresponding to the handling device, the scanning regions of the plurality of 3D laser radars cover both side orientations and the front orientation of the vehicle body 110, the scanning regions are relatively large, the positioning precision of the handling device is high, so even in a complex moving region, the positioning accuracy of the handling device is relatively high.

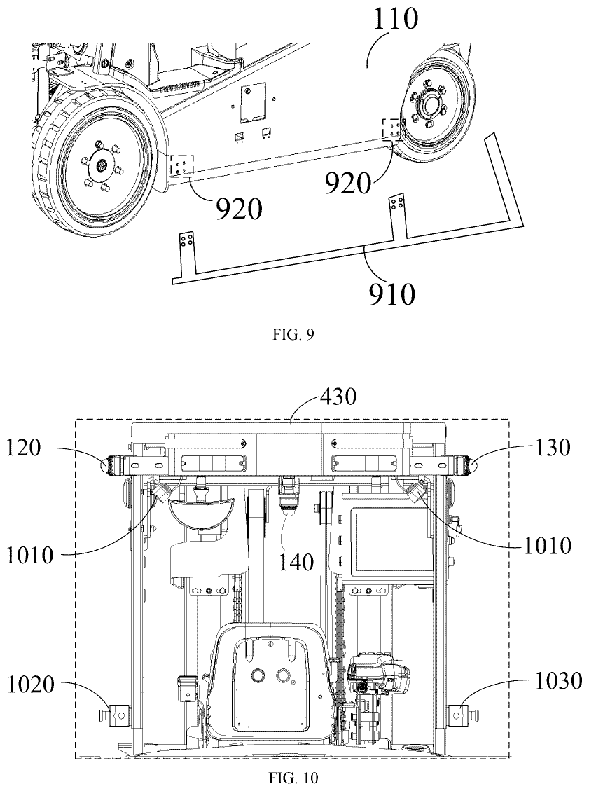

Referring to FIG. 9, in an embodiment, the handling device may further include an anti-collision component 910, and the anti-collision component 910 may be arranged around the vehicle body 110 to reduce damage to the vehicle body 110 caused by the obstacle when the handling device collides with the obstacle. In some embodiments, the vehicle body 110 has a mounting hole 920, and the mounting hole 920 is used to be detachably connected to the anti-collision component 910. In the embodiment, the mounting hole 920 matching the anti-collision component 910 is formed in the vehicle body 110, such that when the anti-collision component 910 needs to be arranged, the anti-collision component 910 is directly mounted on the vehicle body 110 through the mounting hole 920, which improves the configuration flexibility of the anti-collision component 910.

Referring to FIG. 10, in an embodiment, the handling device may further include an outline marker light 1010, the outline marker light 1010 is arranged at the top of the vehicle body 110, and the outline marker light 1010 is configured to show an outline of the vehicle body 110. It should be noted that the outline marker lights 1010 may be configured to emit light ray to show the outline of the vehicle body 110, e.g., showing the height, width, or length of the vehicle body 110. In the embodiment, by providing the outline marker light 1010 on the handling device, a reminding effect may be achieved, so as to prevent other handling device or workers from colliding with the handling device, which improves safety. In an embodiment, referring to FIG. 10, the mounting box 430 is arranged at the top of the front end 313 of the vehicle main body 310, and the outline marker light 1010 is arranged at the bottom of the mounting box 430, so as to be arranged at the top of the vehicle body 110 through the mounting box 430. In some embodiments, the outline marker light 1010 mounted on the handling device is a linear outline marker light. In some embodiments, the handling device may include one, two, or three outline marker lights 1010.

In an embodiment, still referring to FIG. 10, the handling device may further include a first trigger assembly 1020 and/or a second trigger assembly 1030, the first trigger assembly 1020 is arranged on the first side surface 111 of the vehicle body 110, the second trigger assembly 1030 is arranged on the second side surface 112 of the vehicle body 110, both the first trigger assembly 1020 and the second trigger assembly 1030 are in communication connection with the controller 150, and the controller 150 is configured to control the handling device to stop moving when detecting a first trigger operation corresponding to the first trigger assembly 1020 or a second trigger operation corresponding to the second trigger assembly 1030. In the embodiment, by providing the first trigger assembly 1020 and/or the second trigger assembly 1030, the staff may trigger the first trigger assembly 1020 or the second trigger assembly 1030 to instruct the controller 150 to control the handling device to stop moving, which improves the safety of the handling device. In some embodiments, the first trigger assembly 1020 may include a first button, and the first trigger operation may include pressing the first button. In some embodiments, the second trigger assembly 1030 may include a second button, and the second trigger operation may include pressing the second button.

In an embodiment, the handling device may further include a transparent rain cover, the rain cover is covered on the outside of the vehicle body 110, and the rain cover has openings in one-to-one correspondence with the first 3D laser radar 120, the second 3D laser radar 130, and the third 3D laser radar 140. In the embodiment, by covering the rain cover on the outside of the vehicle body 110, the vehicle body 110 and the modules and/or assemblies inside the vehicle body 110 are protected, and meanwhile, by forming openings in one-to-one correspondence with the first 3D laser radar 120, the second 3D laser radar 130, and the third 3D laser radar 140 in the rain cover, the waterproof rain cover may be prevented from affecting the scanning results of the first 3D laser radar 120, the second 3D laser radar 130, and the third 3D laser radar 140. It may be understood that, the first 3D laser radar 120, the second 3D laser radar 130, and the third 3D laser radar 140 are waterproof 3D laser radars, to improve positioning reliability of the handling device.

In an embodiment, the handling device includes a signal emission assembly, the signal emission assembly may be in communication connection with the controller 150, and the controller 150 may be used to control the signal emission assembly to emit information to a charging device in a charging region when the handling device arrives at the charging region, such that the charging device charges the handling device.

It should be noted that, the charging device may be provided with a signal receiving assembly, and in a case where the signal receiving assembly of the charging device receives an emission signal emitted by the signal emission assembly, it indicates that the handling device needs to be charged in the charging region, and the charging device may charge the handling device at this time, to automatically charge the handling device. In some embodiments, the signal emission assembly may include an optoelectronic emitter, and the signal receiving assembly may include an optoelectronic receiver.

An embodiment of the present disclosure further provides a method applied to a handling device, where the handling device includes a vehicle body 110 and a plurality of 3D laser radars provided on the vehicle body 110, and referring to FIG. 12, the method includes:
at step S1201, acquiring, by the plurality of 3D laser radars, 3D point cloud data of environment regions in a plurality of different orientations of the vehicle body 110, where the plurality of different orientations include at least two of a first side orientation, a second side orientation, and a front orientation of the vehicle body; and
at step S1202, determining a pose of the handling device according to the acquired 3D point cloud data.

In an embodiment, the 3D point cloud data of the environment regions in a plurality of different orientations of the vehicle body 110 includes 3D point cloud data of a road surface region in the front orientation of the vehicle body 110, and the method further includes: determining whether there is a void region in the road surface region according to the 3D point cloud data of the road surface region in the front orientation of the vehicle body 110.

In some embodiments, the method further includes: determining whether there is an obstacle in the environment regions in the plurality of different orientations of the vehicle body 110 according to the 3D point cloud data of the environment regions in the plurality of different orientations of the vehicle body 110.

In some embodiments, the handling device further includes a fork assembly 330 for handling a to-be-handled object and an acquisition assembly for acquiring object point cloud data of the to-be-handled object, and the method further includes: determining a pose of the to-be-handled object according to the object point cloud data, to control the fork assembly 330 to handle the to-be-handled object.

The handling device and the method applied to the handling device provided by the embodiments of the present disclosure belong to the same inventive concept, and descriptions of related details and beneficial effects may be referred to each other, and details are not described again.

In the description of the present specification, the description of the terms “some embodiments,” “other embodiments,” “ideal embodiments” and the like means that specific features, structures, materials or features described in connection with the embodiments or examples are included in at least one embodiment or example of the present disclosure. In this specification, the schematic description of the above terms does not necessarily refer to the same embodiments or examples.

In order to make the description concise, all possible combinations of the technical features in the foregoing embodiments are not described, however, as long as there is no contradiction between the combinations of the technical features, it should be considered as the scope of the description.

The above embodiments only express several implementations of the present disclosure, and the description thereof is specific and detailed, but cannot be construed as limiting the scope of the present disclosure. It should be noted that, for those skilled in the art, several modifications and improvements may be made without departing from the concept of the present disclosure, which all fall within the protection scope of the present disclosure. Therefore, the protection scope of the present disclosure shall be defined by the appended claims.

What is claimed is:

1. A handling device, comprising:
a vehicle body;
a plurality of 3D laser radars arranged on the vehicle body, wherein the plurality of 3D laser radars are configured to acquire 3D point cloud data of environment regions in a plurality of different orientations of the vehicle body, and the plurality of different orientations comprise at least two of a first side orientation, a second side orientation, and a front orientation of the vehicle body; and
a controller, arranged on the vehicle body and in communication connection with the plurality of 3D laser radars, wherein the controller is configured to determine a pose of the handling device according to the 3D point cloud data acquired by the plurality of 3D laser radars.

2. The handling device according to claim 1, wherein the plurality of 3D laser radars comprise at least two of a first 3D laser radar, a second 3D laser radar, and a third 3D laser radar; wherein
the first 3D laser radar is arranged on a first side surface of the vehicle body in a width direction and is in communication connection with the controller, and the first 3D laser radar is configured to acquire first 3D point cloud data of an environment region in the first side orientation of the vehicle body;
the second 3D laser radar is arranged on a second side surface of the vehicle body in a width direction and is in communication connection with the controller, and the second 3D laser radar is configured to acquire second 3D point cloud data of an environment region in the second side orientation of the vehicle body;
the third 3D laser radar is arranged on a front end of the vehicle body in a length direction and is in communication connection with the controller, and the third 3D laser radar is configured to acquire third 3D point cloud data of an environment region in the front orientation of the vehicle body.

3. The handling device according to claim 2, wherein at least one of the first 3D laser radar, the second 3D laser radar, the third 3D laser radar, and the controller is arranged at a top of the vehicle body in a height direction.

4. The handling device according to claim 1, wherein the 3D point cloud data of environment regions in the plurality of different orientations of the vehicle body comprises 3D point cloud data of an environment region above the vehicle body, and the environment region above the vehicle body is an environment region above a top of the vehicle body; and
the controller is further configured to: determine whether an obstacle exists in the environment region above the vehicle body according to the 3D point cloud data of the environment region above the vehicle body.

5. The handling device according to claim 1, wherein the 3D point cloud data of environment regions in the plurality of different orientations of the vehicle body comprises 3D point cloud data of a road surface region in the front orientation of the vehicle body; and
the controller is further configured to: determine whether a void region exists in the road surface region according to the 3D point cloud data of the road surface region in the front orientation of the vehicle body.

6. The handling device according to claim 5, wherein the controller is further configured to: when determining that a void region exists in the road surface region in the front orientation of the vehicle body, determine a distance between the handling device and the void region, and control a travel distance of the handling device.

7. The handling device according to claim 2, wherein the vehicle body comprises a vehicle main body and a mounting box, the mounting box is arranged on a front end of the vehicle main body in the length direction, and the controller is arranged inside the mounting box;
wherein the first side surface comprises a first side sub-surface of the vehicle main body and a second side sub-surface of the mounting box, and the second side surface comprises a third side sub-surface of the vehicle main body and a fourth side sub-surface of the mounting box; and
the first 3D laser radar is arranged on the second side sub-surface; and/or
the second 3D laser radar is arranged on the fourth side sub-surface; and/or
the third 3D laser radar is arranged on a bottom of the mounting box in a height direction of the vehicle body.

8. The handling device according to claim 1, further comprising:
a fork assembly, movably connected to a rear end of the vehicle body in the length direction and in communication connection with the controller, the fork assembly being configured to handle a to-be-handled object;
an acquisition assembly, arranged at a rear end of the vehicle body and in communication connection with the controller, the acquisition assembly being configured to acquire object point cloud data of the to-be-handled object; and
wherein the controller is further in communication connection with the fork assembly and the acquisition assembly, and the controller is further configured to determine a pose of the to-be-handled object according to the object point cloud data, to control the fork assembly to handle the to-be-handled object.

9. The handling device according to claim 8, wherein the fork assembly comprises a movable component and two forks,
wherein the movable component is movably connected to the rear end of the vehicle body, the two forks are arranged on the movable component spaced apart, and the acquisition assembly is between the two forks.

10. The handling device according to claim 1, further comprising an angle adjustment assembly,
wherein the angle adjustment assembly is arranged on the vehicle body, and
each 3D laser radar of the plurality of 3D laser radars is arranged on the vehicle body through the angle adjustment assembly, to adjust an angle formed between the 3D laser radar and the vehicle body.

11. The handling device according to claim 1, further comprising at least one of an anti-collision component, an outline marker light, a first trigger assembly, a second trigger assembly, a signal emission assembly, a mast, a mast tilt assembly and an angle detection assembly,
wherein the controller is further in communication connection with the first trigger assembly and the second trigger assembly respectively, and is configured to control the handling device to stop moving in a case where a first trigger operation corresponding to the first trigger assembly or a second trigger operation corresponding to the second trigger assembly is detected;
the controller is further in communication connection with the signal emission assembly, and the controller is configured to control the signal emission assembly to emit information to a charging device of a charging region in a case where the handling device arrives at the charging region, to enable the charging device to charge the handling device;
the vehicle body further comprises the mast, the mast is fixedly connected to a rear end of the vehicle body in a length direction, the mast tilt assembly is connected to the mast, the mast tilt assembly is configured to drive the mast to tilt forward or backward, the angle detection assembly is arranged on the mast, and the angle detection assembly is configured to detect a tilt angle of the mast; and
the controller is further in communication connection with the mast tilt assembly and the angle detection assembly, and the controller is further configured to: receive the tilt angle of the mast sent by the angle detection assembly, and control the mast tilt assembly to adjust the tilt angle of the mast to a target tilt angle according to the tilt angle.

12. The handling device according to claim 1, wherein the controller is further configured to determine whether there is an obstacle in the environment regions in the plurality of different orientations of the vehicle body according to the 3D point cloud data of the environment regions in the plurality of different orientations of the vehicle body.

13. The handling device according to claim 1, wherein the environment regions in the plurality of different orientations of the vehicle body comprise at least two of an environment region in the first side orientation of the vehicle body, an environment region in the second side orientation of the vehicle body, and an environment region in the front orientation of the vehicle body;
wherein the environment region in the first side orientation of the vehicle body comprises an upper environment region in the first side orientation of the vehicle body and a lower environment region in the first side orientation of the vehicle body;
the environment region in the second side orientation of the vehicle body comprises an upper environment region in the second side orientation of the vehicle body and a lower environment region in the second side orientation of the vehicle body; and
the environment region in the front orientation of the vehicle body comprises an upper environment region in the front orientation of the vehicle body and a lower environment region in the front orientation of the vehicle body.

14. The handling device according to claim 1, wherein
scanning regions of two 3D laser radars in the plurality of 3D laser radars partially overlap, or
scanning regions of each 3D laser radar in the plurality of 3D laser radars do not overlap each other.

15. The handling device according to claim 1, wherein the vehicle body comprises a vehicle main body and a mounting box,
wherein the mounting box is arranged at a top of a front end of the vehicle main body in a length direction, and at least one of the plurality of 3D laser radars and the controller is arranged at the mounting box.

16. A method applied to a handling device, wherein the handling device comprises a vehicle body and a plurality of 3D laser radars arranged on the vehicle body, and the method comprises:
acquiring, by the plurality of 3D laser radars, 3D point cloud data of environment regions in a plurality of different orientations of the vehicle body, wherein the plurality of different orientations comprise at least two of a first side orientation, a second side orientation, and a front orientation of the vehicle body; and
determining a pose of the handling device according to the acquired 3D point cloud data.

17. The method according to claim 16, wherein the 3D point cloud data of environment regions in the plurality of different orientations of the vehicle body comprises 3D point cloud data of an environment region above the vehicle body, and the environment region above the vehicle body is an environment region above a top of the vehicle body, and the method further comprises:
determining whether an obstacle exists in the environment region above the vehicle body according to the 3D point cloud data of the environment region above the vehicle body.

18. The method according to claim 16, wherein the 3D point cloud data of environment regions in the plurality of different orientations of the vehicle body comprises 3D point cloud data of a road surface region in the front orientation of the vehicle body; and
the method further comprises: determining whether a void region exists in the road surface region according to the 3D point cloud data of the road surface region in the front orientation of the vehicle body.

19. The method according to claim 16, further comprising: determining whether there is an obstacle in the environment regions in the plurality of different orientations of the vehicle body according to the 3D point cloud data of the environment regions in the plurality of different orientations of the vehicle body.

20. The method according to claim 16, wherein the handling device further comprises: a fork assembly for handling a to-be-handled object and an acquisition assembly for acquiring object point cloud data of the to-be-handled object, and the method further comprises:
determining a pose of the to-be-handled object according to the object point cloud data, to control the fork assembly to handle the to-be-handled object.
